(19) United States
(12) Patent Application Publication
(10) Pub. No.: US 2017/0134447 A1
(43) Pub. Date: May 11, 2017

(54) REAL TIME VOICE PARTICIPATE SELF-ASSESSMENT

(71) Applicant: International Business Machines Corporation, Armonk, NY (US)

(72) Inventors: Heather L. Duschl, Raleigh, NC (US); Alexandra D. Markello, Fayetteville, NC (US); Dana L. Price, Surf City, NC (US)

(21) Appl. No.: 14/933,613

(22) Filed: Nov. 5, 2015

(51) Int. Cl. H04L 29/06

(52) U.S. Cl. CPC H04L 65/403; H04L 65/604; H04L 65/1083

(57) ABSTRACT

Aspects include a method, a system and a computer program product for performing a sound quality self-assessment on a voice conference. The method includes determining that a first participant of the voice conference wants to perform a sound quality self-assessment. A first voice conference connection of the first participant is muted from other participants. The first participant's voice is recorded. The recording of the first participant's voice is played back to the first participant. The first voice conference connection is unmuted.

### BACKGROUND

The present invention relates generally to a voice communications system and, more specifically, to a method and system that allows a participant in a group voice conference to self-assess the quality of their voice in the conference.

Conference call systems are widely used to allow groups of people to talk on a common/shared voice line. Conference call systems allow participants to join the voice call using a variety of systems including traditional land-line phones, cellular phones, voice-over-internet-protocol (VOIP) systems, and the like. As a result, conference systems allow participants from geographically dispersed locations to converse. Due to the variety of systems that can connect and variations in the interconnections between the different participants, the sound quality of a participant's voice can be different for each of the other participants and also change over the course of the conference call.

### SUMMARY

Embodiments include a method, system, and computer program product for performing a sound quality self-assessment on a voice conference. The method includes determining that a first participant of the voice conference wants to perform a sound quality self-assessment. A first voice conference connection of the first participant is muted from other participants. The first participant's voice is recorded. The recording of the first participant's voice is played back to the first participant. The first voice conference connection is unmuted.

Additional features are realized through the techniques of the present invention. Other embodiments and aspects of the invention are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features of embodiments of the invention are apparent from the following detailed description taken in conjunction with the accompanying drawings in which:

FIG. 1 depicts a cloud computing environment in accordance with some embodiments of this disclosure;

FIG. 2 depicts abstraction model layers according to an embodiment of this disclosure;

FIG. 3 depicts a block diagram of voice conferencing system according to an embodiment of this disclosure;

FIG. 4 depicts a flow diagram of a method of a participant self-assessing the sound quality on a voice conference in accordance with an embodiment of this disclosure;

FIG. 5 depicts a flow diagram of a method of a participant self-assessing the sound quality of their voice on their system in accordance with an embodiment of this disclosure; and

FIG. 6 depicts a flow diagram of a method of a participant self-assessing the sound quality of their voice on another participants system in accordance with an embodiment of this disclosure.

### DETAILED DESCRIPTION

Embodiments of the present disclosure are directed to a voice conferencing system that provides users with the ability to perform self-assessments of the sound quality of their voice on the conference system. Some embodiments of the present disclosure may provide features in allowing a user to perform the self-assessment for sound quality without disturbing the other participants on the conference system. Still further embodiments of the present disclosure may provide features in allowing a user to perform a self-assessment of the sound quality of their voice on another participant's voice connection.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

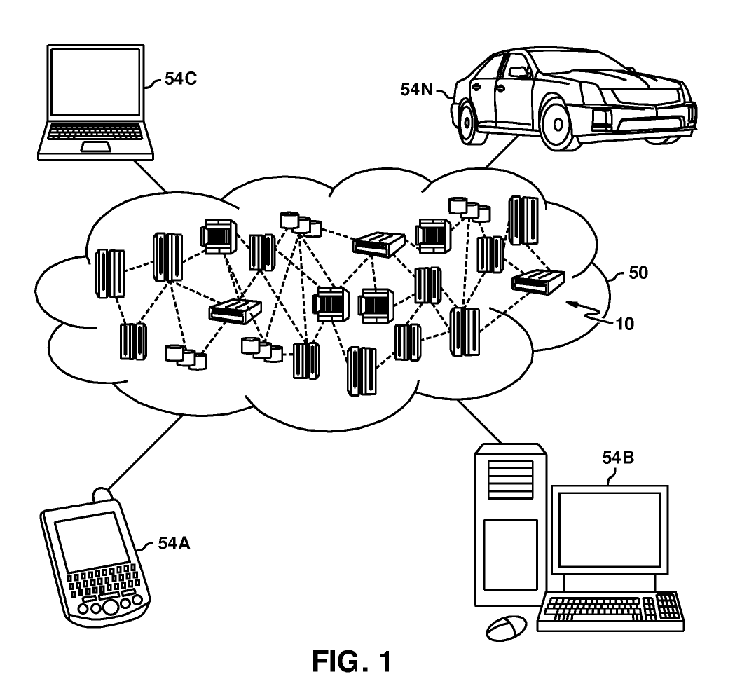

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

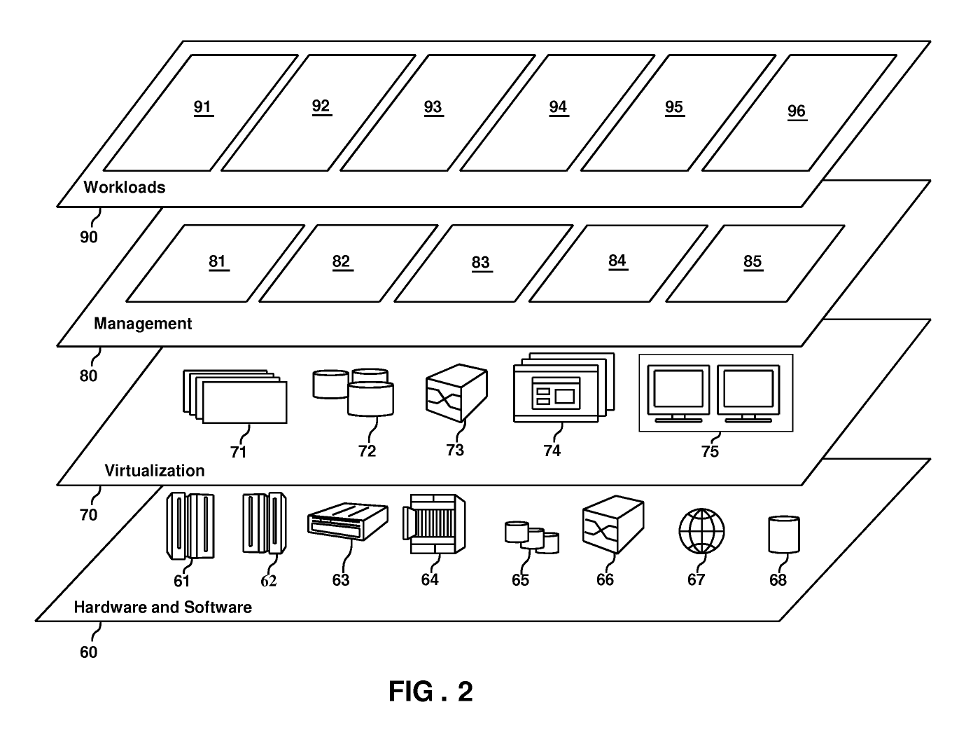

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:
Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.
Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.
In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.
Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a voice conferencing system 96 that provides methods that allow users to perform self-assessments of the quality of their voice on a conference call.

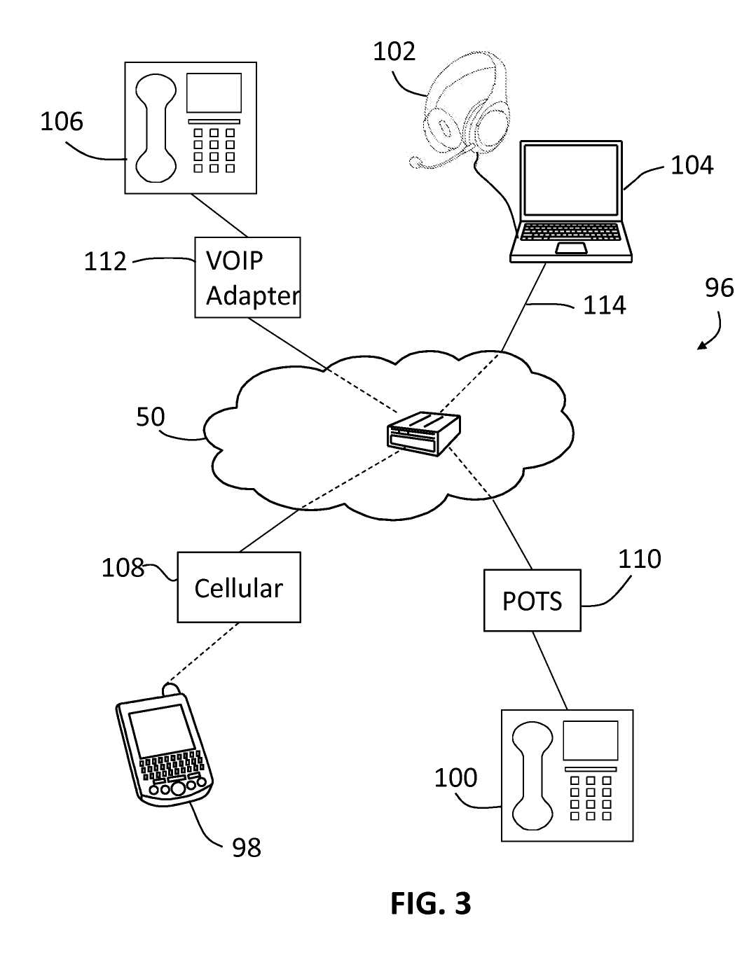

Turning now to FIG. 3, a voice conferencing system 96 is shown that allows geographically dispersed participants to participate in a voice conference. The system 96 allows participants to connect using a variety of different devices, such as but not limited to: a cellular phone 98, a land-line based telephone 100, using a headset 102 or a microphone on a laptop computer 104 and a VOIP telephone device 106. Each of these devices may be connected via the cloud computing environment 50 using a variety of different telecommunication or computer-based systems. For example, the cellular phone 98 may connect using a cellular network 108. It should be appreciated that the cellular phone 98 may also connect to the system 96 using VOIP and a wireless (e.g. WiFi) connection. The land-line based telephone 100 may connect to the system 96 using a POTS (plain-old-telephone-service) system 110. The VOIP telephone device 106 may connect via an intermediary VOIP system 112. The laptop computer 104 connects to the cloud computing environment 50 through a computer network, such as that provided by an Internet Service Provider (ISP) 114.

It should be appreciated that since participants connect to the system 96 using systems based on different telecommunications technologies and networks, the sound quality for participants may vary widely. The sound quality variation may change from conference session to conference session and also change over the course of a given conference session. Further, a particular participant may sound differently to different conference participants. For example, User A that is using the cellular phone 98 may perceive the sound quality of User B on the land-line based telephone 100 as being good. However, User C that is communicating through headset 102 may perceive User B's sound quality as being poor. This may be due to a variety of factors including interconnections on the user's telecommunications network (e.g. the ISP's computer network) or the user's equipment (e.g. the connection quality of headset 102 to the laptop computer 104).

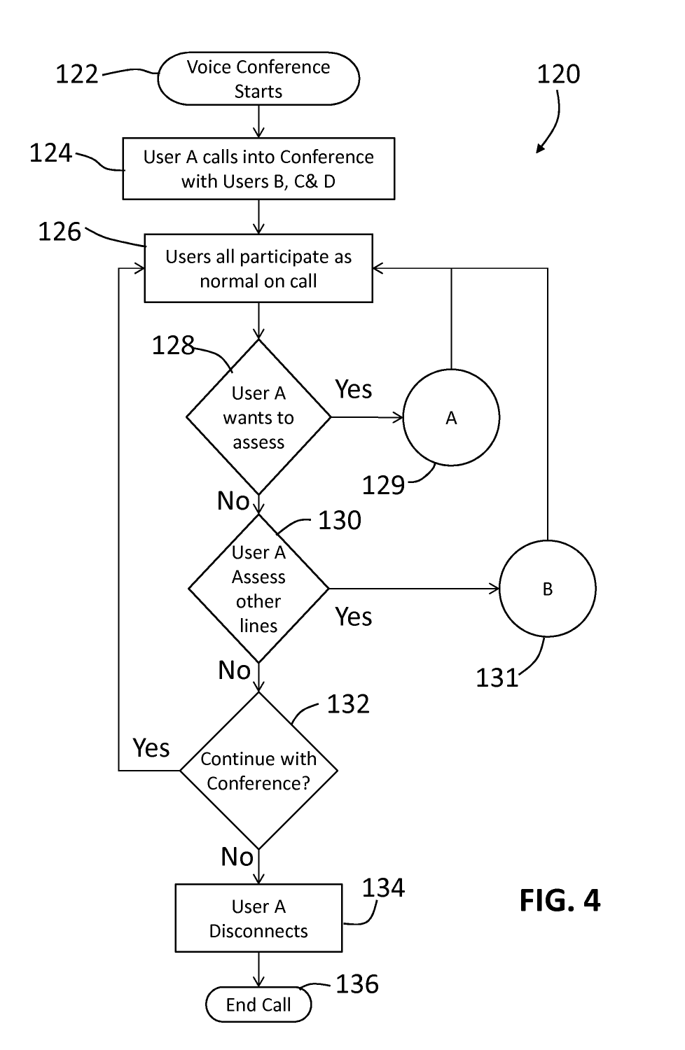

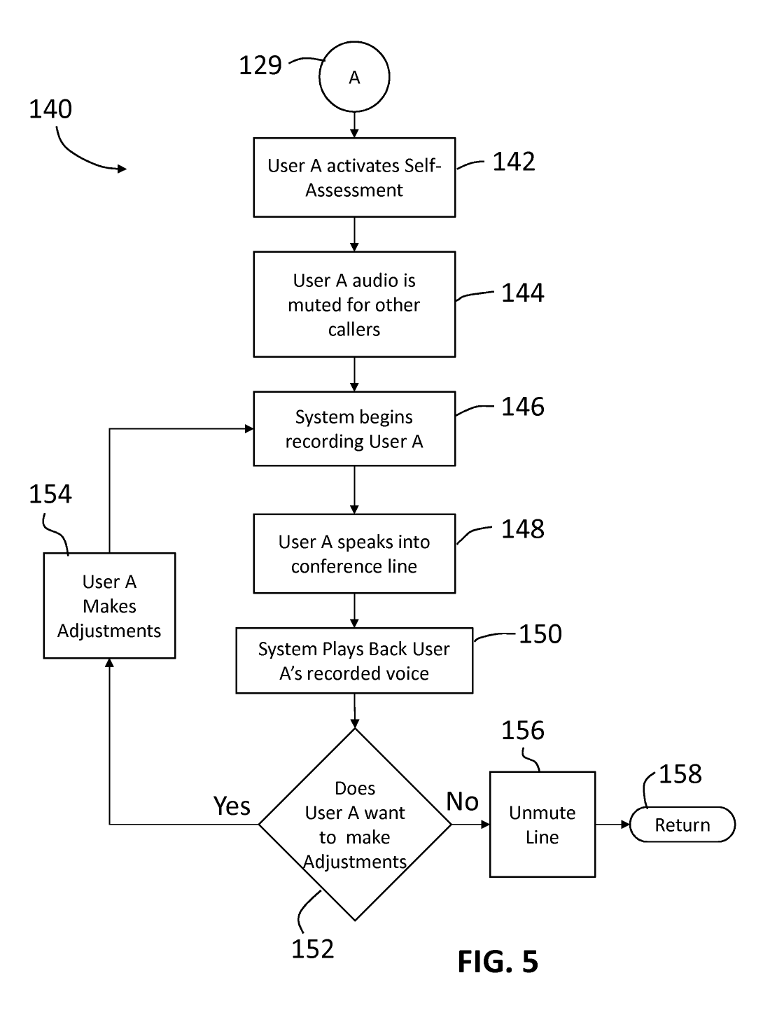

It is often difficult for a given user of the system 96 to know how they sound to the other participants in general or to specific participants. Referring now to FIG. 4, a method 120 is provided for allowing each participant in a voice conference to perform a self-assessment of the sound quality of their voice. The method 120 starts in block 122 where the voice conference starts and User A (e.g. from cellular phone 98) connects to the voice conference with at least one other user in block 124. The method 120 proceeds to block 126 where the users participate on the voice conference. At query block 128 it is determined whether User A wants to perform a self-assessment of sound quality for their device and connection. A user may indicate to the system 96 that a self-assessment is desired by entering a predetermined number sequence, using their telephone key pad for example, such as #123 for example. In other embodiments, the self-assessment process may be activated by selecting an option in the voice conferencing computer program application being used to participate in the voice conference. When query block 128 returns a positive, meaning User A wants to perform a self-assessment of their connection to the system 96, the method 120 proceeds to block 129 and will be described in more detail herein with reference to FIG. 5.

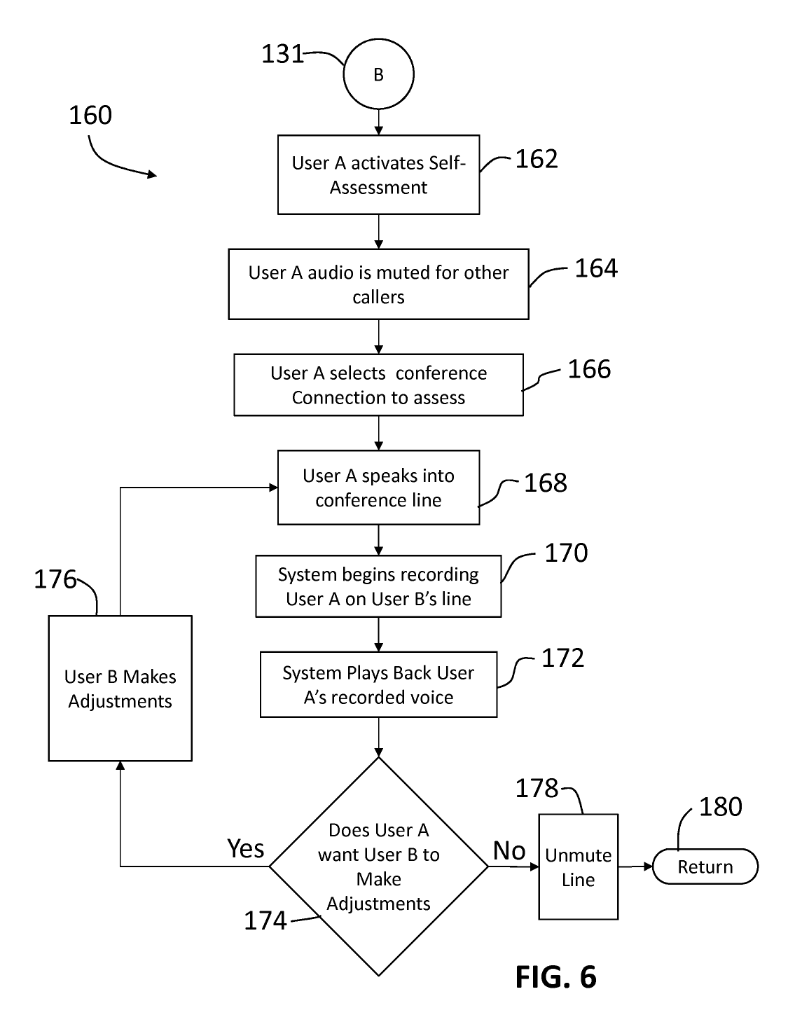

When query block 128 returns a negative, the method 120 proceeds to query block 130 where it is determined whether User A wants to perform a self-assessment of sound quality of their voice on a connection of one of the other voice conference participants. The user may indicate to system 96 that this self-assessment is desired by entering a predetermined sequence, such as #124 on their telephone keypad for example, or by selecting an option in their voice conferencing computer program application. When query block 130 returns a positive, the method 120 proceeds to block 131 and will be described in more detail herein with reference to FIG. 6.

When query block 130 returns a negative, the method 120 proceeds to query block 132 where it is determined whether User A desires to continue on the voice conference. When query block 132 returns a positive, the method 120 loops back to block 126. When the query block 132 returns a negative, the method 120 proceeds to block 134 where User A disconnects from the voice conference and the method 120 terminates in block 136. It should be appreciated that while the illustrated embodiment describes the method 120 with respect to a single user, e.g. User A, this is for exemplary purposes and the claimed invention should not be so limited. The self-assessment methods described herein may be used by any of the participants on the voice conference system 96.

Turning now to FIG. 5, a method 140 is shown for allowing a user to perform a self-assessment of the sound quality of their connection and local voice conference device. The method 140 starts in block 129 in response to the user indicating, in method 120 for example, that they would like to check the sound quality of their connection. It should be appreciated that there are a number of factors that determine the sound quality characteristics for a particular voice conference participant. These factors include, but are not limited to: the microphone type (e.g. handset, speaker phone or headset), distance of the microphone from the user, the quality of the connections of the voice conference devices (e.g. the telephone connector, a USB plug to the computer) and user voice characteristics (e.g. volume/loudness, pitch, articulation, speed). It should be appreciated that some of these sound quality characteristics are within the user's control and may be changed to improve the sound quality. For example, adjustments may be made by the user such as disconnecting (e.g. hanging up) and reconnecting (e.g. dialing back into the system). Other adjustments may include repositioning the microphone, switching between speaker phone and a handset, or plugging and unplugging connectors to the computer for example. However, since the user cannot hear how they sound to other participants, it is difficult for the user to know when or what types of changes should be performed. The method 140 provides the user with the ability to determine the quality of their voice and make changes to their local environment, devices and speech patterns to improve the quality.

The method 140 first proceeds to block 142 where User A activates the self-assessment. User A's audio is then muted in block 144 with respect to other participants in the voice conference system 96. The method 140 proceeds to block 146 where User A's voice is recorded as User A speaks into their voice conferencing device (e.g. cellular phone 98) in block 148. In one embodiment, the system 96 prompts the user to recite a predetermined sequence of words or phrases that provide a range or spectrum of phonetic sounds. The predetermined sequence of words or phrases may be selected to include phonetic sounds that may cause quality issues with voice conferencing devices (e.g. microphones) such as words that include hard constants (e.g. words that begin or end with the letter “p”) or words that begin or end with the letter “s” for example. The method 140 then proceeds to block 150 where the recorded voice of User A is played back to User A on their voice conference device. It should be appreciated that User A's line is still muted to the other participants of the voice conference and this self-assessment may be performed without the other participants knowing.

The method 140 then proceeds to query block 152 where it is determined whether User A wants to make any adjustments, such as to their equipment (e.g. move the microphone) or to their speech pattern. When query block 152 returns a positive, the method 140 proceeds to block 154 where User A makes the desired changes and the method 140 loops back to block 146. In one embodiment, the system 96 analyzes the user's recorded speech and provides feedback on possible improvements that may be made (e.g. check USB connection, change to handset, move microphone). This feedback may be audio, or where the user is using a voice conference computer program application, displayed on their computer monitor screen. When query block 152 returns a negative, the method 140 proceeds to block 156 and unmutes the voice conference connection for User A before returning in block 158 to method 120 as described above.

Turning now to FIG. 6, a method 160 is provided for allowing a user to assess the sound quality of their voice as it sounds to other selected participants in the voice conference. The method 160 begins in block 162 where User A activates the self-assessment. In block 164, the audio from User A's voice conference connection is muted with respect to the other participants. The method 160 then proceeds to block 166 where User A selects which other participant of the voice conference that the user wants to assess the sound quality of their voice, such as the voice conference connection of User B for example. The method 160 then proceeds to block 168 where User A speaks and their voice is recorded in block 170 on the connection of User B. In one embodiment, the recording may be performed, for example, using the voice conference device of User B. The method 160 then proceeds to block 172 where the recorded voice of User A from User B's voice conference connection is played back to User A. In one embodiment, the recording data of User A's voice is transmitted back to User A's voice conference system before being played back. It should be appreciated that in some embodiments this may provide for removing connection quality factors between User A and User B from altering the sound quality of the recorded voice from being played back to User A.

The method 160 then proceeds to query block 174 where it is determined if any adjustments may be made. For example, User A may unmute their voice conference connection and ask User B to make adjustments to their voice conferencing device (e.g. switch from speaker phone to a headset). Alternatively, User A may decide to make adjustments to their voice conference device (e.g. move the microphone) or change their speech patterns in an attempt to improve the sound quality of User A's voice on User B's voice conference connection. When query block 174 returns a positive, the respective user makes adjustments to improve the sound quality in block 176 and the method 160 loops back to block 168. When query block 174 returns a negative, the method 160 proceeds to block 178 and unmutes the voice conference connection for User A before returning in block 180 to method 120 as described above.

Technical effects and benefits of some embodiments include allowing a user of a voice conferencing system to make adjustments to monitor the sound quality of their voice based on a self-assessment without disturbing other participants of the voice conference. Technical effects and benefits of some embodiments also include allowing users of a voice conferencing system to perform self-assessments and determine when sound quality issues exist. The user may then make adjustments to improve the sound quality of their voice conference connection. Still further technical effects and benefits of some embodiments include allowing a user of a voice conferencing system to monitor the sound quality of their voice on other users' voice conference connections.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for performing a sound quality self-assessment on a voice conference, the method comprising:
determining that a first participant of the voice conference requests to perform the sound quality self-assessment;
muting a first voice conference connection of the first participant from other participants;
recording a voice of the first participant;
playing the recording of the first participant's voice back to the first participant; and
unmuting the first voice conference connection from the other participants.

2. The method of claim 1 wherein the recording the first participant's voice is performed on the first voice conference connection.

3. The method of claim 1 wherein the recording the first participant's voice is performed on a second voice conference connection of a second participant.

4. The method of claim 3 wherein the recording of the first participant's voice is performed by a voice conference device of the second participant.

5. The method of claim 4 further comprising transmitting the recording from the voice conference device to the first participant.

6. The method of claim 3 further comprising making an adjustment by the second participant to improve a sound quality of the first participant's voice.

7. The method of claim 1 further comprising prompting the first participant to recite predetermined phrases for recording.

8. The method of claim 1 further comprising making an adjustment by the first participant to improve a sound quality characteristic.

9. The method of claim 1 wherein the determining that the first participant wants to perform a self-assessment enables unilaterally provisioning computing capabilities to perform the muting the first voice conference connection, the recording the first participant's voice and the playing back the recording to the first participant.

10. A system for performing a sound quality self-assessment on a voice conference, the system comprising:
a memory having computer readable instructions; and
one or more processors for executing the computer readable instructions, the computer readable instructions comprising:
determining that a first participant of the voice conference wants to perform the sound quality self-assessment;
muting a first voice conference connection of the first participant from other participants;
recording a voice of the first participant;
playing the recording of the first participant's voice back to the first participant; and
unmuting the first voice conference connection to the other participants.

11. The system of claim 10 wherein the recording the first participant's voice is performed on a second voice conference connection of a second participant.

12. The system of claim 11 wherein the recording of the first participant's voice is performed by a voice conference device of the second participant.

13. The system of claim 12 further comprising transmitting the recording from the voice conference device to the first participant.

14. The system of claim 11 further comprising making an adjustment by the second participant to improve a sound quality of the first participant's voice.

15. The system of claim 10 further comprising prompting the first participant to recite predetermined phrases for recording.

16. The system of claim 10 further comprising making an adjustment by the first participant to improve a sound quality characteristic.

17. A computer program product for performing a sound quality self-assessment on a voice conference, the computer program product comprising a computer readable storage medium having program instructions embodied therewith, the program instructions executable by a processor to cause the processor to perform:
determining that a first participant of the voice conference wants to perform the sound quality self-assessment;
muting a first voice conference connection of the first participant from other participants;
recording a voice of the first participant;
playing the recording of the first participant's voice back to the first participant; and
unmuting the first voice conference connection to the other participants.

18. The computer program product of claim 17 wherein the recording the first participant's voice is performed on a second voice conference connection of a second participant.

19. The computer program product of claim 18 further comprising making an adjustment by the second participant to improve the sound quality of a first participant's voice.

20. The computer program product of claim 17 further comprising making an adjustment by the first participant to improve a sound quality characteristic.
